(19) United States
(12) Patent Application Publication
(10) Pub. No.: US 2007/0220305 A1
(43) Pub. Date: Sep. 20, 2007

(54) Multiplex server system and server multiplexing method

(75) Inventor: Kazuhiko Isoyama, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, Tokyo (JP)

(21) Appl. No.: 11/723,499

(22) Filed: Mar. 20, 2007

(30) Foreign Application Priority Data
Mar. 20, 2006 (JP) 2006-076929

(51) Int. Cl. G06F 11/00

(52) U.S. Cl. 714/4

(57) ABSTRACT

A multiplex server system is provided for processing events from clients in accordance with a plurality of set rules, with the intention of reducing the cost of a computer system which comprises spare servers. In the multiplex server system, a plurality of servers are provided, and a primary server and a secondary server are arbitrarily selected on a rule-by-rule basis. A server which is a primary server in which a rule has been set notifies a client of an event processing result at all times, whereas a server which is a secondary server in which a rule is set notifies the client of an event processing result only in the event of a failure of the primary server in which the rule has been set.

### BACKGROUND OF THE INVENTION

1. Field of the Invention

The present invention relates to a multiplex server system and a method for multiplexing servers in a computer system which has an active server and a spare server.

2. Description of the Related Art

Japanese Patent No. 3008887, for example, discloses a computer system which comprises an active server that is normally used, and a spare server that is used when the active server fails.

One of such a system, i.e., a conventional system which has duplexed servers, will be described with reference to FIG. 1.

A system illustrated in FIG. 1 defines, on a server-by-server basis, primary server 602a which is an active server, and a secondary server 602b which is a spare server.

As source client 604 transmits event 609, this event 609 is allocated to primary server 602a and secondary server 602b by dispatcher 601. Primary server 602a and secondary server 602b perform the same processing, and mutually confirm survival 608 of each other. When primary server 602a is surviving, only primary server 602a transmits result 611 to destination client 605, whereas secondary server 602b does not transmit result 612. Then, when primary server 602a fails, secondary server 602b detects the failure, and starts transmitting result 612, thus accomplishing the duplexing of servers.

The conventional example illustrated in FIG. 1 has, a problem that it costs twice as much because a secondary server is required for every primary server.

Recent computer systems generally comprise a plurality of servers which are interconnected to process multiple events, but when the configuration illustrated in FIG. 1 is applied to such a system, the resulting system will need twice as many servers as those which actually perform the processing.

### SUMMARY OF THE INVENTION

The present invention has been made in view of the problem inherent in the prior art as described above, and it is an object of the invention to reduce the cost of a computer system which has spare servers.

In one aspect, the present invention provides a multiplex server system which has a plurality of servers coupled to one another to process a multiplicity of events. The system comprises:

a rule allocator for determining a plurality of rules for defining a primary server and a secondary server for processing events, among the plurality of servers, allocating the rules to each server, and providing a dispatch rule for determining a rule for use with each of the events; and

a dispatcher for receiving the events to be processed and the allocation rule, copying the event to be processed, and dispatching the copied events along with the dispatch rule to servers defined as the primary server and the secondary server, as indicated by the dispatch rule.

Each of the servers comprises:

a rule table for describing whether the server is a primary server or a secondary server to which each of the rules will be applied, and for describing a primary server when the server is a secondary server;

a server survival table for storing survival states of the plurality of servers; and

a controller, upon receipt of the event dispatched from the dispatcher, for confirming with reference the rule table whether the server is defined as a primary server or a secondary server, causing the server to deliver a processed result of the event when the server is defined as a primary server, and causing the server, when the server is defined as a secondary server, to deliver the processed result of the event when no primary server has survived (server has not failed ) based upon in the server survival table.

In this system, the rule allocator may not determine a secondary server in accordance with the rule.

Also, the rule allocator may define a larger number of primary servers than the number of secondary servers among the plurality of servers.

In another aspect, the present invention provides multiplex server system which has a plurality of servers coupled to one another to process a multiplicity of events. The system comprises:

a rule allocator for determining a plurality of rules for defining priorities for servers which process events among the plurality of servers, allocating the rules to each server, and providing a dispatch rule for determining a rule for use with each of the events; and

a dispatcher for receiving the events to be processed and the dispatch rule, copying the events to be processed, and dispatching the copied events to servers determined to process the events indicated by the dispatch rule.

Each of the servers comprises:

a rule table for describing priorities for the server itself and for servers which are given higher priorities than the server itself for each of the rules;

a server survival table for storing survival states of the plurality of servers; and

a controller, responsive to receipt of the events dispatched from the dispatcher, for confirming the priority of the server with reference to the rule table, causing the server to deliver a processing result of the event when the server is given the highest priority, and referring to the server survival table when the server is given a low priority and causing the server to deliver the processing result of the event when there is no surviving server that has been given a priority higher than the server.

In a further aspect, the present invention provides a method of multiplexing servers, implemented in a multiplex server system which has a plurality of servers coupled to one another to process a multiplicity of events.

The method comprises:

determining a plurality of rules for defining a primary server and a secondary server for processing an event, among the plurality of servers, allocating the rules to each server, and determining a dispatch rule for use with each of the events;

copying the event to be processed, and dispatching the copied events along with the dispatch rule to servers defined as the primary server and the secondary server, as indicated by the dispatch rule; and

upon receipt of the dispatched event, each of the servers confirming whether each server is defined as a primary server or a secondary server with reference to the rule table, delivering a processed result of the event when the server is defined as a primary server, and referring to the server survival table when the server is defined as a secondary server, and delivering the processing result of the event when there is no surviving primary server.

In this method, a secondary server may not be defined in accordance with the rule.

Also, the method may comprise defining a larger number of primary servers than the number of secondary servers among the plurality of servers.

In a yet further aspect, the present invention provides a method for multiplexing servers implemented in a multiplex server system which has a plurality of servers coupled to one another to process a multiplicity of events. The method comprises:

determining a plurality of rules for defining priorities for servers which process events among the plurality of servers, allocating the rules to each server, and defining a dispatch rule for determining a rule for use with each of the events;

copying the events to be processed, and dispatching the copied events to servers determined to process events indicated by the dispatch rule; and

each of the servers confirming the priority of the server with reference to the allocation rule and the rule table, delivering a processing result of the event when the server is given the highest priority, and referring to the server survival table when the server is given a low priority and delivering the processing result of the event when there is no surviving server that has been given a priority higher than the server.

According to the present invention, anti-failure control can be selected for each processing rule, thus making it possible to conduct flexible anti-failure control. For example, a secondary rule may be set only for important rules, but not for minor ones, such that the important rule alone take over in the event of a failure, thereby enabling operations that have reduced functions, should a failure occur. Also, server-based failover requires one backup per server and therefore requires twice as many resources, whereas the present invention facilitates adjustment of anti-failure resources by adjusting the allocation of rules (uniformly allocating primary rules and secondary rules among servers, setting secondary rules only for important rules, and the like).

### BRIEF DESCRIPTION OF THE DRAWINGS

FIG. 1 is a diagram illustrating the configuration of a conventional example;

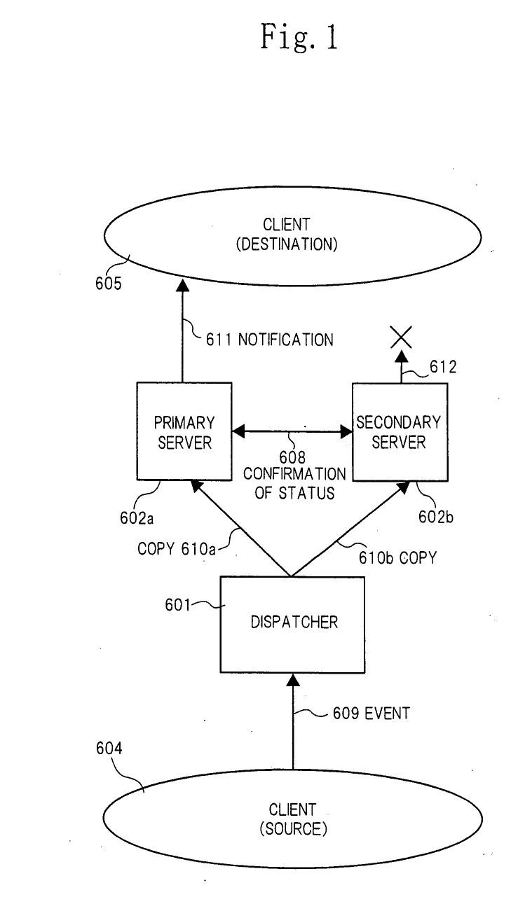

FIG. 2 is a block diagram illustrating the configuration of a first embodiment of a system according to the present invention;

FIG. 3 is a diagram illustrating a main internal configuration of a server;

FIG. 4 is a diagram illustrating a main internal configuration of the server;

FIG. 5 is a diagram illustrating a main internal configuration of the server;

FIG. 6 is a block diagram illustrating the configuration of a second embodiment according to the present invention; and

FIG. 7 is a diagram illustrating a main configuration of a third embodiment according to the present invention.

### DETAILED DESCRIPTION OF THE PREFERRED EMBODIMENTS

Next, embodiments of the present invention will be described with reference to the drawings.

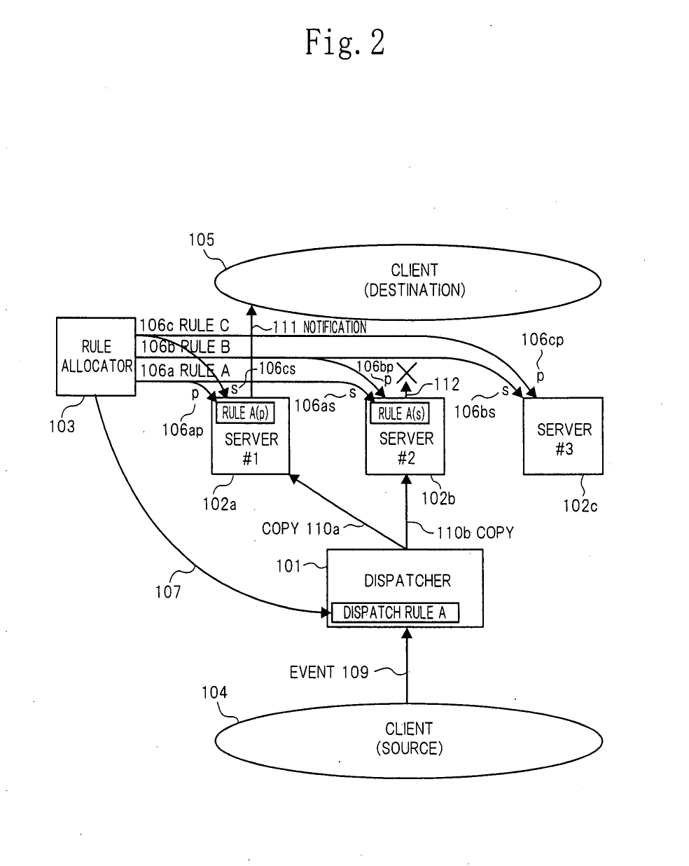

FIG. 2 is a block diagram illustrating the configuration of a first embodiment of a system according to the present invention.

The system of this embodiment comprises a plurality of servers 102a-102c (server #1-#3), dispatcher 101, and rule allocator 103. The system communicates with source client 104 and destination client 105. While FIG. 2 shows source client 104 and destination client 105 separately from each other, they may be the same.

Each of dispatcher 101, servers 102a-102c, and rule allocator 103 is implemented by a general computer which comprises a controller, a memory, an input device, and a display device. These components are not shown or particularly described below, but the operation of each component is controlled by the controller which operates in accordance with a program stored in the memory. Also, while dispatcher 101, servers 102a-102c, and rule allocator 103 are shown independently of one another, they may be combined into a single data processing apparatus.

Respective servers 102a-102c interconnect through a bus, not shown, to confirm the survival of one another. This confirmation of survival is made using broadcast packets, for example, when the Ethernet is employed.

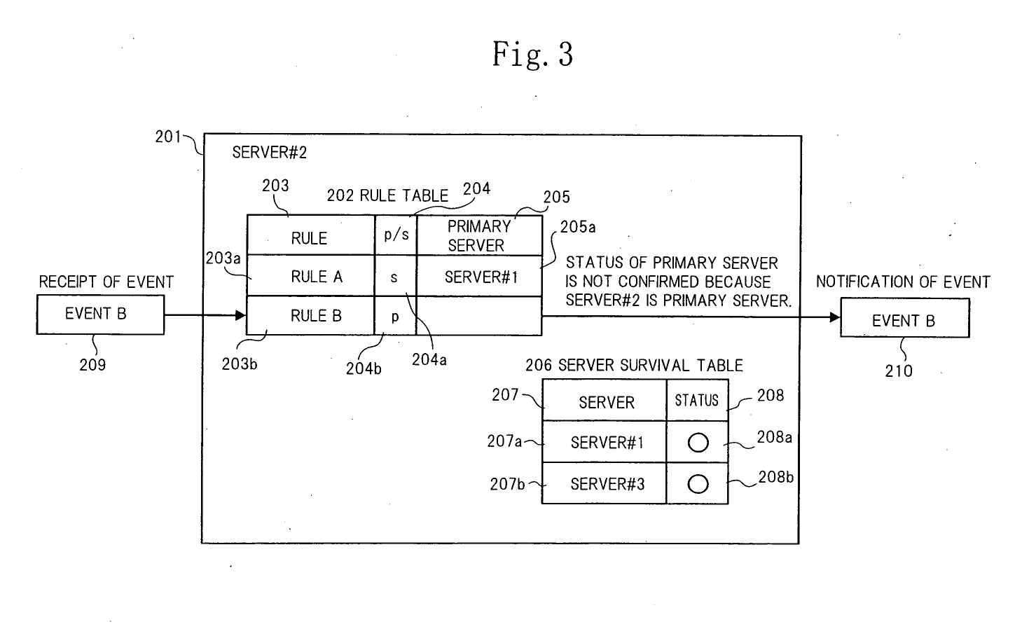

FIG. 3 is a diagram illustrating a main internal configuration of each server 102a-102c. While FIG. 3 illustrates the internal configuration of server 102b (server #2), which is designated by server 201 as an example, all the servers comprise the same configuration.

Each server 102a-102c contains rule table 202 and server survival table 206.

Rule table 202 stores the following items: rule 203 which describes a plurality of processing rules; flag 202 which indicates on a rule-by-rule basis whether server #2 is primary or secondary; and primary server 205 which describes a primary server which is set by an associated rule when server #2 is a secondary server.

In FIG. 3, rule 203 describes processing rules 203a (rule A), 203b (rule B); flag 202 describes flags 204a (secondary), 204b (primary); and primary server 205 describes server 205a which is a primary server in rule A.

Server survival table 206 holds survival information 208a, 208b on server names 207a, 207b other than server #2. In the example shown in FIG. 3, server survival table 206 holds the survival information on servers 102a, 102c (server #1, server #3), where “o” is stored for indicating that both servers are surviving.

Each server processes events based on the processing rule. The processing may involve simply notifying destination client 105 of an event when it is detected, performing calculations and a search, modification and the like of a database based on the contents of each event, performing processing based on a plurality of events (averaging a plurality of sensor data and the like), and so forth. For the purpose of simplicity, the following description of the embodiment will be made on the assumption that destination client 105 is notified of an event when it is detected, for simplicity.

Next, the operation of this embodiment will be described.

In this embodiment, there are three rules to be set: rule A (106a), rule B (106b), and rule C (106c). Rule allocator 103 selects a server which is set as primary and a server which is set as secondary, on a rule-by-rule basis, and sets the rules therein.

For example, in rule A (106a) in FIG. 2, rule allocator 103 selects server #1 (102a) as a primary server, and server #2 (102b) as a secondary server, and sets primary rule (106ap) and secondary rule (106as) in the selected servers, respectively.

Likewise, in rule B (106b), rule allocator 103 selects server #2 (102b) as a primary server, and server #3 (102c) as a secondary server, and sets primary rule (106bp) and secondary rule (106bs) in the selected servers, respectively. Also, in rule C (106c), rule allocator 103 selects server #3 (102c) as a primary server, and server #1 (102a) as a secondary server, and sets primary rule (106cp) and secondary rule (106cs) in the selected servers, respectively.

Rule allocator 103 also sets dispatch rule 107 in dispatcher 101 such that events to be processed in accordance with a rule set in each server are transferred to the server. For example, in FIG. 2, since the primary rule (106ap) and secondary rule (106as) of rule A (106a) have been set in server #1 (102a) and server #2 (102b), respectively, dispatch rule 107 is set such that event A (109) to be processed in accordance with rule A (106a) is transferred to server #1 (102a) and server #2 (102b). While omitted in FIG. 2, dispatch rules are set in a similar manner such that events to be processed in accordance with rule B (106b) and rule C (106c) are transferred to associated servers. Dispatcher 101 also comprises a rule table similar to that contained in each server to recognize a primary server and a secondary server which perform processing in accordance with the dispatch rule. The contents of the rule table in dispatcher 101 may be delivered by rule allocator 103 and described therein in a similar manner to each server, or may be previously defined.

Subsequently, as an event is transmitted from source client (104), dispatcher 101 transfers the event to a server which has a rule set therein which is relied on to process the event, such that the server processes the event. In this event, the servers confirm the survival of one another, and a server which has a primary rule set therein transmits the processing result to destination client 105, whereas a server which has a secondary rule set therein does not transmit the processing result to destination client 105 when the server having the primary rule set therein is normal, and transmits the processing result to destination client 105 in the event of a failure in the server which has the primary rule set therein.

When event A (109) is transmitted from source client 104 as shown in FIG. 2, dispatcher 101 transfers copied events A (110a, 110b) to server #1 (102a) and server #2 (102b), respectively, which have rules A (106ap, 106as) set therein which are relied on to process event A.

Server #1 (102a) and server #2 (102b), which have received events A (110a, 110b), process events A (110a, 110b) in accordance with rules A (106ap, 106as), respectively, where server #1 (102a) having primary rule (106ap) set therein alone delivers notification 111 (processing result) to destination client 105 when server #1 (102a) is normal, whereas server #2 (102b) having the secondary rule set therein does not notify destination client 105 of processing result 112. However, upon failure of server #1 (102a) which has primary rule (106ap) set therein, when server #2 (102b), which has secondary rule (106as) set therein, detects the failure of server #1 (102a) and receives event A (110b), server #2 (102b) notifies destination client 105 of processing result 112.

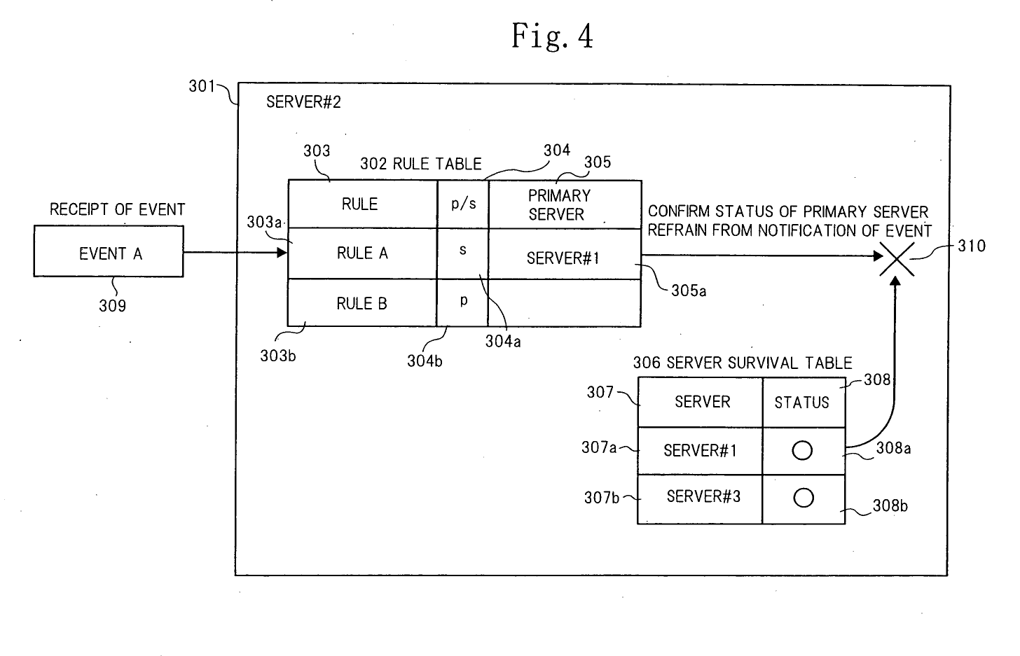

The operation of each server will be described with reference to FIGS. 3 and 4 giving server #2 (102b) as an example.

In FIG. 3, server #2 (102b) is designated by server 201. Rule table 202 in server 201 sets secondary rule 203a of rule A and primary rule 203b of rule B in rule 203. Rule table 202 also sets flag 204 which indicates whether a set rule is primary or secondary, and sets server 205 which has the primary rule set therein when server 201 has the secondary rule set therein. In addition, the server contains server survival table 206 for holding survival information on the servers, which is always updated by the results of survival confirmation communications among the servers.

The operation performed upon receipt of an event related to the primary rule will be described with reference to FIG. 3. Upon receipt of event B (209), server 201 searches rule table 202 for rule B (203b) related to event B (209). Then, while server 201 processes event B (209) in accordance with rule B (203b), server 201 notifies processing result (210), as it is, to the clients, because it can be seen from primary/secondary flag (204b) in rule table (202) that rule B (203b) is the primary rule.

Referring to FIG. 4, a description will be given of the operation of a server which has received an event related to the secondary rule when a server having the primary rule set therein is normal.

In FIG. 4, server #2 (102b) is designated by server 301. Other components designated by reference numerals beginning from “20-” in FIG. 3 are replaced with those designated by reference numerals beginning from “30-.”

Upon receipt of event A (309), server 301 searches rule table 302 for rule A (303a) related to event A (309). Then, while server 301 processes event A (309) in accordance with rule A (303a), it can be seen from primary/secondary flag 304a in rule table 302 that rule A (303a) is the secondary rule. In response, server 301 processes event A (309) in accordance with rule A (303a), and subsequently searches primary server information 305 within rule table 302 for server #1 (305a), and searches server survival table 306 for survival information 307a on server #1. As a result, server 301 refrains from notified the processing result, because survival information 307a describes contents 308a which indicate that server #1 is normal.

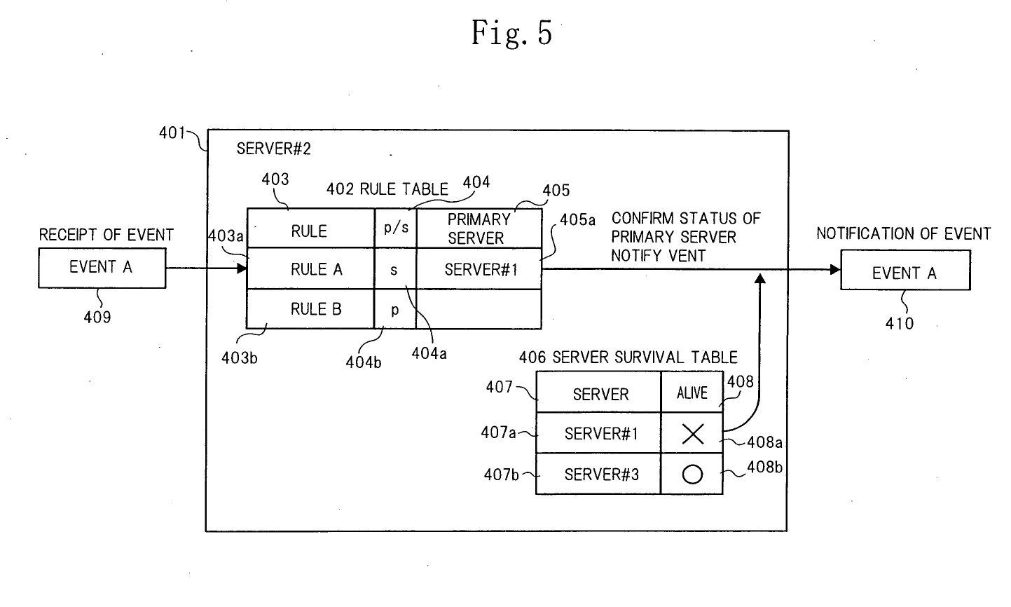

Referring to FIG. 5, a description will be given of the operation of a server which has received an event related to the secondary rule in the event of a failure in a server which has the primary rule set therein.

In FIG. 5, server #2 (102b) is designated by server 401. Also, the other components which are designated by reference numerals beginning from “20-” in FIG. 3 are replaced with those designated by reference numerals beginning from “40-.”

The operation performed in this scenario is similar to that when the primary server is normal, from the receipt of event A (409), processing of event A (409) in accordance with rule A (403a), up to the search for survival information (407a) on the primary server. When server 401 knows from the result of searching for survival information (407a) on server #1 that it describes contents (408a) which indicate that server #1 fails, server 401 notifies client 105 of processing result (410) of event A.

While FIG. 2 shows that the number of rules is equal to the number of servers, this is for convenience of illustration only and such a limitation is not imposed. For example, the number of servers may not be equal to the number of rules.

Also, while the secondary rule is set in every rule in FIG. 2, a secondary rule may be set only for important rules, but not for minor ones, such that the important rules alone take over in the event of a failure, thereby enabling operations that have reduced functions, should a failure occur.

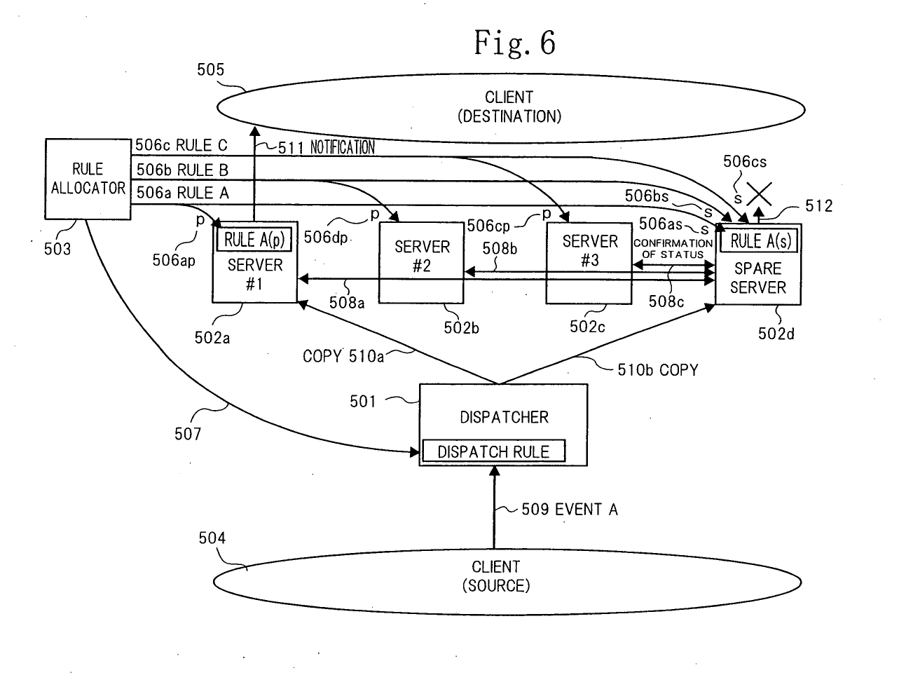

FIG. 6 is a block diagram illustrating the configuration of a second embodiment according to the present invention.

A system according to this embodiment comprises a plurality of servers 502a-502c (server #1-server #3), spare servers 502d which serve as spares for respective servers 502a-502c, dispatcher 501, and rule allocator 503. Also, the system communicates with source client 504 and destination client 505. While FIG. 6 shows source client 504 and destination client 505 separately from each other, they may be the same.

In this embodiment, one spare server 502d is provided for a plurality of processing servers 502a-502c for normal processing of rules, and all secondary rules of all rules are set in spare server 502d. In this way, the duplication of n servers can be accomplished only with a single spare server instead of n spare servers which would be otherwise required. Alternatively, since a single spare server will be burdened with a high spare server load, m (m<n) spare servers may be provided, and the secondary rule may be set in these spare servers in a similar manner. In this way, by selecting a primary server and a secondary server on a rule-by-rule basis, it is possible to flexibly set the ratio of the number of active servers to the number of spare servers.

Each server processes an event based on a processing rule. The processing may involve simply notifying destination client 505 of an event when it is detected, performing calculations and a search, modification and the like of a database based on the contents of each event, performing processing based on a plurality of events (averaging a plurality of sensor data and the like), and so on. For the purpose of simplicity, the following description of the embodiment will be made on the assumption that destination client 505 is notified of an event when it is detected, for simplicity.

Next, the operation of this embodiment will be described.

In this embodiment, there are three rules to be set: rule A (506a), rule B (506b), and rule C (506c). Rule allocator 503 sets a designated server as the primary server on a rules by rule basis, and always selects server 502d for the secondary server.

For example, in rule A (506a) in FIG. 6, server #1 (502a) is selected as a primary server, while spare server 502d is selected as a secondary server, and primary rule (506ap) and secondary rule (506as) are set in server #1 (502) and spare server 502d, respectively.

Likewise, in rule B (506b), server #2 (506b) is selected as a primary server, while spare server 502d is selected as a secondary server, and primary rule (506bp) and secondary rule (506bs) are set in server #2 and spare server 502d, respectively. In addition, in rule C (506c), server #3 (506c) is selected as a primary server, while spare server 502d is selected as a secondary server, and primary rule (506cp) and secondary rule (506cs) are set in server #3 and spare server 502d, respectively.

Rule allocator 503 sets dispatch rule 507 in dispatcher 501 such that an event to be processed by a rule set in each server is transferred to that server. For example, in FIG. 6, since server #1 (502a) and spare server (502d) have primary rule (506ap) and secondary rule (506as) of rule A (506a) set therein, respectively, allocation rule 507 is set such that event A (509) to be processed in accordance with rule A (506a) is transferred to server #1 (502a) and spare server 502d. Though omitted in FIG. 6, allocation rules are set in a similar manner such that events to be processed in accordance with rule B (506b) and rule C (506c) are transferred to primary servers 502b, 502c and spare server 502d, respectively.

Subsequently, as an event is transmitted from source client 504, dispatcher 501 transfers the event to a primary server and to spare server 502d which have a rule set therein which is relied on to process the event, such that the primary server and spare server 502d process the event. In this event, the primary server and spare server 502d have confirmed the survival of each other, and the server which has a primary rule set therein transmits the processing result to destination client 505, whereas spare server 502d which has a secondary rule set therein does not transmit the processing result to destination client 505 when the server having the primary rule set therein is normal, and transmits the processing result to destination client 505 in the event of a failure in the server which has the primary rule set therein.

As event A (509) is transmitted from source client 504 as in FIG. 6, dispatcher 501 transfers copied events A (510a, 510b) to server #1 (502a) and to spare server 502d which have rules A (506ap, 506as) set therein which are relied on to process event A.

Server #1 (502a) and spare server 502d, which have received events A (510a, 510b), process events A (510a, 510b) in accordance with rules A (506ap, 506as), respectively, where server #1 (502a) which has primary rule (506ap) set therein alone delivers notification 511 (processing result) to destination client 505 when server #1 (502a) is normal, while spare server 502d which has secondary rule (506as) set therein does not notify processing result 512. However, upon failure of server #1 (502a) having primary rule 506ap set therein, when spare server 502d, which has secondary rule 506 as set therein, detects the failure of server #1 (102a) and receives event A (510b), spare server 502b notifies destination client 505 of processing result 512.

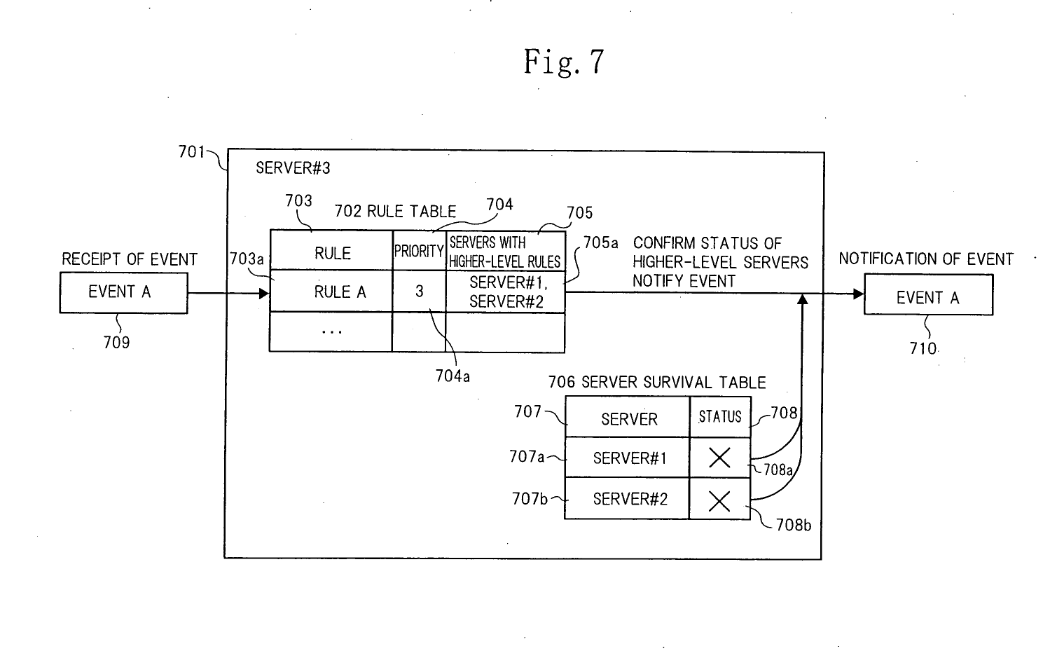

FIG. 7 is a diagram illustrating a main configuration of a third embodiment according to the present invention.

This embodiment is generally similar in configuration to the first embodiment illustrated in FIG. 2 and the second embodiment illustrated in FIG. 6, but differs from those in the structure of tables in each server. In the following, this embodiment will be described using the reference numerals shown in FIG. 6.

FIG. 7 is a diagram illustrating a main internal configuration of each server 502a-502c. While FIG. 7 illustrates the internal configuration of server 701 which represents server 503c (server #3), all the servers comprise similar configurations.

Each server contains rule table 702 and server survival table 706.

Rule table 702 stores the following items: rule 703 which describes a plurality of processing rules, priority 704 of server #3 for each rule; and primary server 705 which describes a primary server in which a higher rank server than server #3 is set.

In FIG. 7, rule table 702 describes processing rule 703a (rule A) in rule 703; third (704a) in priority 702; and contents 705a of server #1 and server #2 in primary server 705.

Server survival table 706 holds survival information 708a, 708b on server 707a, 707b other than server #3 itself. In the example shown in FIG. 7, server survival table 706 holds survival information on servers 702a, 702b (server #1, server #2), and stores “X” for both servers, indicating that they have not survived.

As described above, in this embodiment, ternary rule (703a) is set in server #3 (701) in addition to the setting of the primary rule of rule A in server #1, and the secondary rule in server #2. In this event, rule table (702) sets priority 704a for that rule (703a), and server (705a) in which the higher priority rule is set.

Upon receipt of event A (709) consistent with rule (703a), server 701 processes event A (709) based on rule 703a, but notification of event (710) result is provided only in the event of failures in both server #1 (707a) and server #2 (707b) in which higher priority rules of that rule (703a) are set, with reference to server survival table (706), and otherwise (when any of server #1 [(707a)] and server #2[ (707b)] survives) does not notify the processed result. In this way, this embodiment enables not only duplexing but also multiplexing of servers.

1. A multiplex server system which has a plurality of servers coupled to one another to process a multiplicity of events, said system comprising:
a rule allocator for determining a plurality of rules for defining a primary server and a secondary server for processing events, among said plurality of servers, allocating the rules to each said server, and providing a dispatch rule for determining a rule for use with each of the events; and
a dispatcher for receiving the events to be processed and the dispatch rule, copying the event to be processed, and dispatching the copied events along with the dispatch rule to servers defined as the primary server and the secondary server, as indicated by the dispatch rule,
wherein each of said servers comprises:
a rule table for describing whether said server is a primary server or a secondary server for each of said rules, and for describing a primary server when said server is a secondary server;
a server survival table for storing survival states of said plurality of servers; and
a controller, upon receipt of the event rule dispatched from said dispatcher, for confirming with reference to said rule table whether said server is defined as a primary server or a secondary server, causing said server to deliver a processed result of the event when said server is defined as a primary server, and causing said server, when said server is defined as a secondary server, to deliver the processed result of the event when no primary server survives with reference to said server survival table.

2. The multiplex server system according to claim 1, wherein:
said rule allocator does not define a secondary server in accordance with the rule.

3. The multiplex server system according to claim 1, wherein:
said rule allocator defines a larger number of primary servers than the number of secondary servers among said plurality of servers.

4. A multiplex server system which has a plurality of servers coupled to one another to process a multiplicity of events, said system comprising:
a rule allocator for determining a plurality of rules for defining priorities for servers which process events among said plurality of servers, allocating the rules to each server, and providing a dispatch rule for determining a rule for use with each of the events; and
a dispatcher for receiving the events to be processed and the dispatch rule, copying the events to be processed, and dispatching the copied events to servers determined to process the events indicated by the dispatch,
wherein each of said servers comprise:
a rule table for describing priorities for said server itself and for servers which are given higher,.priorities than said server itself for each of the rules;
a server survival table for storing survival states of said plurality of servers; and
a controller, responsive to receipt of the events dispatched from said dispatcher, for confirming the priority of said server with reference to the rule table, causing said server to deliver a processing result of the event when said server is given the highest priority, and referring to said server survival table when said server is given a low priority and causing said server to deliver the processing result of the event when there is no surviving server that has been given a priority higher than the server.

5. A method of multiplexing servers, implemented in a multiplex server system which has a plurality of servers coupled to one another to process a multiplicity of events, said method comprising:
determining a plurality of rules for defining a primary server and a secondary server for processing an event, among said plurality of servers, allocating the rules to each of said servers, and determining a dispatch rule for use with each of the events;
copying the event to be processed, and dispatching the copied events along with the-dispatch rule to servers defined as the primary server and the secondary server, as indicated by the dispatch rule; and
upon receipt of the dispatched event, each of said servers confirming whether each of said servers is defined as a primary server or a secondary server with reference to the rule table, delivering a processing result of the event when said server is defined as a primary server, and referring to the server survival table when said server is defined as a secondary server, and delivering the processing result of the event when there is no surviving primary server.

6. The method for multiplexing servers according to claim 5, comprising:
not defining a secondary server in accordance with the rule.

7. The method for multiplexing servers according to claim 5, comprising:
defining a larger number of primary servers than the number of secondary servers among said plurality of servers.

8. A method for multiplexing servers implemented in a multiplex server system which has a plurality of servers coupled to one another to process a multiplicity of events, said method comprising:
determining a plurality of rules for defining priorities for servers which process events among said plurality of servers, allocating the rules to each server, and defining a dispatch rule for determining a rule for use with each of the events;
copying the events to be processed, and allocating the copied events to servers determined to process events indicated by the allocation rule, along with the allocation rule; and
each of said servers confirming the priority of said server by referring to the rule table, delivering a processing result of the event when said server is given the highest priority, and referring to said server survival table when said server is given a low priority and delivering the processing result of the event when there is no surviving server that has been given a priority higher than the server.

9. The multiplex server system according to claim 2, wherein:
said rule allocator defines a larger number of primary servers than the number of secondary servers among said plurality of servers.

10. The method for multiplexing servers according to claim 6, comprising:
defining a larger number of primary servers than the number of secondary servers among said plurality of servers.
